(19) United States
(12) Patent Application Publication
(10) Pub. No.: US 2008/0076343 A1
(43) Pub. Date: Mar. 27, 2008

(54) Portable clean air cart

(75) Inventor: Seth Allen Pyers, West Bloomfield, MI (US)

Correspondence Address: THE WEINTRAUB GROUP, P.L.C.;SUITE 240, 32000 NORTHWESTERN HWY., FARMINGTON HILLS, MI, 48334, US

(73) Assignee: Vectech Pharmaceutical Consultants

(21) Appl. No.: 11/901,431

(22) Filed: Sep. 17, 2007

Related U.S. Application Data
(60) Provisional application No. 60/844,899, filed on Sep. 15, 2006.

(51) Int. Cl. B60H 1/00

(52) U.S. Cl. 454/141; 454/156

(57) ABSTRACT

A self-contained transport cart provides a clean air environment to an interior compartment thereof for sensitive products being moved from one clean air environment to another clean air environment while passing through a lesser clean air environment. An air managing system and air filtration system therefor continuously circulates air within the cart and removes particulates from air drawn forced into the interior compartment to ensure that that the compartment air is both clean and not stagnant.

### CROSS-REFERENCE TO RELATED APPLICATION

This application claims the benefit of U.S. Provisional Application No. 60/844,899, filed Sep. 15, 2006, the disclosure of which is incorporated herein in its entirety.

### BACKGROUND OF THE INVENTION

1. Field of the Invention

The present invention pertains to a transport cart providing a clean air environment to an interior compartment thereof for sensitive products being moved from one clean air environment to another clean air environment while passing through a lesser clean air environment, and more particularly, to an air managing system and air filtration system therefor that continuously circulates air within the cart and removes particulates from air drawn forced into the interior compartment to ensure that that the compartment air is both clean and not stagnant.

2. Description of the Prior Art

In many industries, the use of a “clean-room” is known. These clean air facilities are large, and generally expensive. However, certain manufacturing steps may require that sensitive items be transported from one clean air environment to another clean air environment while passing through a lesser clean air area. This may happen when transporting the sensitive items within a common facility or during transportation across town, such as in a truck or the like. In either situation, the sensitive items must be continuously protected from contamination due to exposure to the surrounding air.

Accordingly, there is a need in many industries for a transport cart having a sealable, yet accessible, storage area or compartment that provides a “clean-room” or clean air environment to sensitive products such as semiconductor wafers, computer components, pharmaceuticals, surgical devices and devices used in medicine, and other products against contamination during manufacture, storage or transportation.

The clean room typically utilizes a filter system to remove unwanted contaminants. For example, the prior art has used activated charcoal filter for ASHRAE rated filters, refrigeration, and air conditioning engineering elements, specially configured filter elements, plate, and a clean room high efficiency particulate (“HEPA”) filter. In some of these systems removing charge from air stream is used to prevent electrostatic discharges, special sensors are required to warn the user when the filter needs replacement.

The HEPA filter is desirable in that it does not require frequent cleaning, and/or replacement. Importantly, the HEPA filter used to reduce the number of contaminants in indoor air is known to arrest or stop at least 99.97% to 99.99 of all particles 0.3 microns or larger.

Further, a transport cart that does not provide for air circulation may result in stagnant air in the clean room area. This is not desirable in some industries because the product being protected may give off contaminants that need to be removed. In some transport carts, the air may be caused to circulate but unwanted particles are not removed from the air.

Accordingly, an object of this invention is the provision of transport cart, which is portable, provided with a storage compartment for transporting articles, and includes an air management system and an air filtration system for maintaining a clean room environment in the storage compartment, and a self-contained power for air circulation and air quality monitoring system.

An important object of this invention is to provide in a portable transport cart a storage compartment with a supply of air that is continuously circulating, air that is substantially of “clean room” quality and/or free of contaminants, and that obviates the presence of stagnant air.

According to another important object of this invention, the cart being self-contained and operable both under DC or AC power sources to operate an air management system in cooperative relation with an air filtration system to provide a source of positive air pressure in the storage compartment, and continuously circulate and filter air presented to the storage compartment.

Another important object of this invention is a portable clean-air cart with a storage compartment and a door adapted to substantially seal but permit access to the storage compartment, which cart provides an environment to the compartment that is substantially contamination free, whether or not the door is sealed. Positive air pressure in the compartment prevents unwanted air, exterior to the compartment, from entering the storage compartment.

Another important object according to this invention is a clean-air storage compartment, wherein a filter continuously removes contaminants from entering the storage area and spaced walls of diffuser flow control plates with differently arranged arrays of apertures cooperate to provide laminar airflow between opposite end walls of the compartment.

The portable transfer cart and air management and air filtration systems thereof cooperate to provide the storage compartment with an air environment that is essentially that of a “clean-room” and substantially free of unwanted particulates and contaminants.

### SUMMARY OF THE INVENTION

These and other objects according to the present invention are attained in a portable clean air cart providing a storage compartment to house and transport at least one workpiece in an environment segregated from the environment external to the storage compartment, the portable clean air cart comprising:

a housing that defines an accessible substantially airtight compartment for storing sensitive items being moved from one clean air environment to another clean air environment while passing through a lesser clean air environment, and

an air managing and air filtration system for continuously circulating air within and through the compartment and removing particulates from air circulated into the compartment to ensure that the chamber is clean and not stagnant.

According to this invention, the housing includes an interior chamber, said interior chamber being subdivided to include said storage compartment, said storage compartment including an air inlet and outlet, respectively, for passing air into and out of said compartment, a first region for receiving and presenting circulated air to said air inlet, a second region for receiving air expelled from said air outlet, and a third region for passing air from said second region to said first region, and the air managing and air filtration system includes a fan and an air filter, said fan for circulating air inside the interior chamber of the housing and presenting air to achieve uniform air flow at the desired velocity pressure to said air filter, and said air filter being juxtaposed with said air inlet for removing contaminants from air received from the fan and prior to being circulated into said compartment.

Further, the air managing system preferably includes air control means for providing a generally uniform air-flow between the inlet and outlet of the compartment, and the fan operates to provide a positive pressure in said compartment wherein to obviate stagnant air and expel contaminated air from the compartment. Desirably, the fan operates to force air outwardly of the storage compartment. Should the access door be left ajar, the fan will force air outwardly of the compartment and inhibit contaminated air from entering the compartment.

In a preferred embodiment, the air control means comprises the inlet and outlet, respectively, being formed in part, by a plate having an array of air flow openings provided therein, the array of air flow openings in the inlet plate being aligned with the air flow openings in the outlet plate.

According to an aspect of this preferred embodiment, the storage compartment is subdivided into upper and lower storage areas, and the air control means comprises the inlet and the outlet, respectively, being formed, in part, by upper and lower plates each having an array of air flow openings provided therein, the array of openings in the upper plates and lower plates being aligned with one another.

According to another aspect of this preferred embodiment, the storage compartment includes three storage areas, the inlet and outlet to the storage areas comprise, respectively; an upper, a center, and a lower plate, each with an array of air flow openings, with the openings in the plates of the inlet being chosen to provide uniform flow across all three shelves. Further, the array of openings in the upper plates form two triangular arrays, each array having its apex in a top corner of the plate. The array of openings in the center plates formed a rectangular or square grid, at the center of the plate. The array of openings in the lower plates formed two triangular arrays, each array having its apex in a bottom corner of the plate.

It should be noted that the desired velocities dictate the number and configuration of the perforations so that velocities are substantially the same (±20%) across each shelf in a laminar flow. Thus, the perforations may or may not be co-axial.

According to this invention, the storage areas of the storage compartment are accessible by one or more openable doors, wherein the positive pressure in the compartment by the fan continuously operates to expel filtered air from the compartment and inhibit contaminated air from entering into the compartment.

The air management means further comprised air diffuser means disposed at the outlet to the fan.

According to a preferred embodiment, the cart is self-contained and carries means for connecting the fan to a source of electrical power, the means for powering carried by the cart and operable to power the cart to AC or DC sources of electricity. Additionally, the electrical power capability includes a DC battery, and an inverter, an appropriate cabling for connecting the fan to the battery or to an external source of AC electricity. In an aspect, the battery and inverter are mounted atop a slide out tray, and the housing includes a removable panel to permit access to the battery and the inverter.

According to a preferred embodiment, the cart is provided with means for detecting pressure drop, wherein to determine if the filter is remaining effective or needs to be changed. In this regard, an induction tube, proximate to the filter, and a readout pressure gauge are provided.

According to a preferred embodiment, the cart is provided with air inlet means for introducing constant supply of exterior air to the interior chamber, and distal to said fan. In this regard, a grille dimensioned to pass a suitable volume of air, without interfering with the fan operation, air circulation, or pressure drop, is provided. Desirably, the grille is proximate to the DC battery and forms the access panel, which panel also directs air across the battery for cooling purposes.

The portable cart further comprises access means for gaining access to said first region, wherein the filter and fan may be separately inspected for maintenance, inspection, removal, and replacement as needed.

The present invention will be more clearly understood with reference to the accompanying drawings and to the following Detailed Description, in which like reference numerals refer to like parts and where:

### BRIEF DESCRIPTION OF THE DRAWINGS

FIG. 1 is a perspective view of a portable clean air cart according to the present invention with portions forming the exterior right side of the cart removed to show various interior chambers therein, including a central storage compartment for transporting sensitive products, and chambers for carrying air management apparatus and circulating air through the chambers of the cart.

FIG. 2 is an elevation view of the right side of the clean air cart of FIG. 1;

FIG. 3 is an elevation view of the right side of the clean air cart of FIG. 1 with portions thereof removed to show the chambers in the cart and the air management and filtration apparatus;

FIG. 4 is a rear-elevation view of the clean air cart showing removable panels for accessing air filtration apparatus in the cart;

FIGS. 5 and 6 are front elevation views of the clean air cart shown in FIG. 2, respectively, with FIG. 5 showing a vertical wall and an inlet grille and FIG. 6 having the vertical wall removed to show an interior chamber and apparatus carried within the cart, and

FIG. 7 shows detail of a smoke induction tube.

### DETAILED DESCRIPTION OF A PREFERRED EMBODIMENT

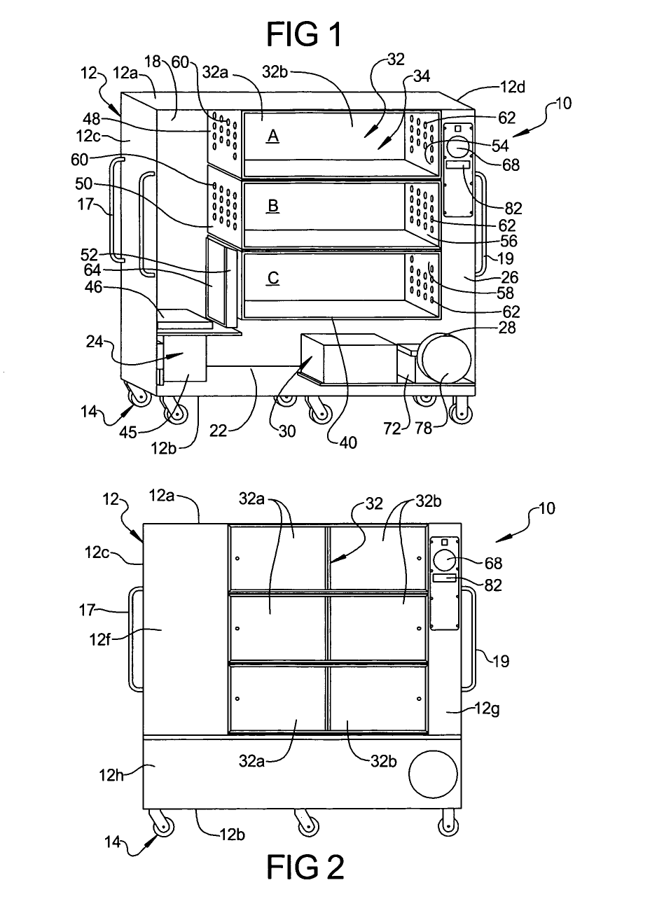

Turning now to the drawings, FIGS. 1-7 illustrate a portable clean air cart 10 according to the present invention. The transport cart 10 is adapted to be both transportable and provide a sealable, yet accessible, storage area or compartment that provides a “clean-room” or clean air environment to sensitive products such as semiconductor wafers, computer components, pharmaceuticals, surgical devices and devices used in medicine, and other products against contamination during manufacture, storage or transportation.

Preferably, and according to important aspects of this invention, the transport cart is self-contained and maintains a clean air environment, which enables the user to load and unload sensitive items in air environments that are clean and transport the sensitive items in air environments that are not of the requisite cleanliness. In this regard, the cart 10 includes various access doors or panels to provide access to the compartment, such as for loading and unloading of the sensitive products into the cart for transport, or to provide access to various chambers therein, such as to maintain apparatus carried by the cart and/or replace air filters used therein. In addition to providing a “transportable clean air environment” the cart includes an air management and air filtration system that continuously circulates air, under pressure, and removes contaminants from air in the compartment, thus obviating stagnant air in the storage compartment from degrading the items to be transported.

The transport cart 10 is generally rectangular-shaped and comprises a housing 12 supported on an array of wheels or casters 14 that enable the cart to be moved. The housing 12 is formed by generally horizontally disposed top and bottom panels 12a and 12b, generally vertically disposed rear and front panels 12c and 12d, and a left side panel 12e.

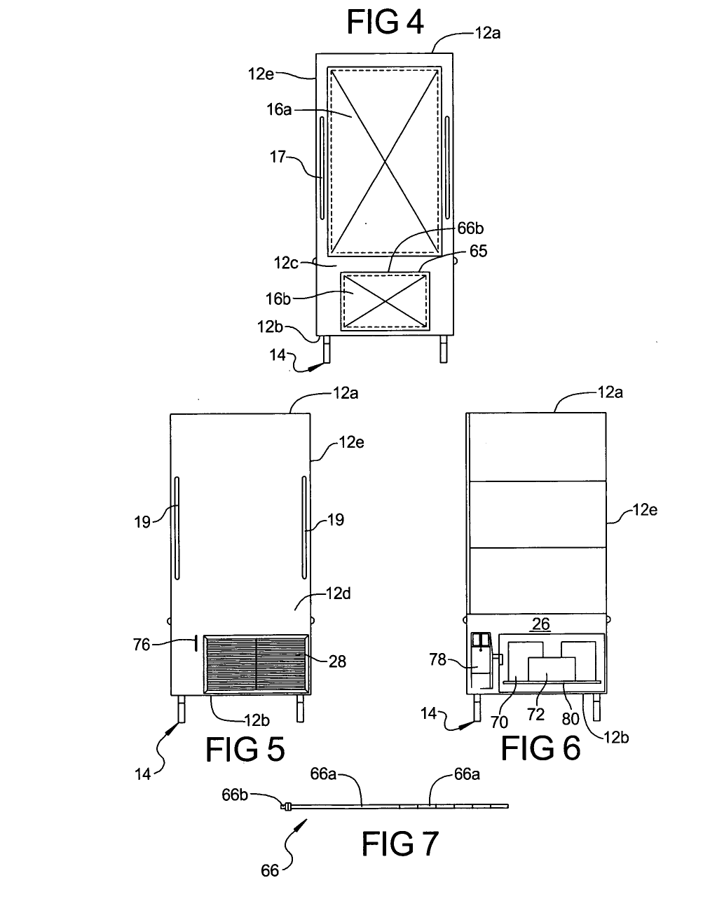

As shown best in FIGS. 1 and 4, the trailing side of the housing 12 is formed by the rear panel 12c and includes a pair of removable access panels 16a and 16b and a pair of handles 17. The access panels 16a and 16b are sealingly secured to the panel 12c and are removable therefrom to permit access, respectively, into an interior upper chamber 18 of the cart, whereby to gain access to air filtration apparatus 20 therein, and an interior lower chamber 22 of the cart, whereby to gain access to air management apparatus 24 disposed therein, at least in part.

As shown best in FIGS. 5 and 6, the leading side of the housing 12 is formed by the rear panel 12d, which panel is disposed in covering relation with and, in part, forms an interior upper chamber 26 and the interior lower chamber 22. The panel 12d includes a pair of handles 19 and a grate or grille 28 that permits exterior air to be sucked into the interior lower chamber 22 of the cart. The grille 28 is removable and permits access to operating apparatus 30 disposed in the interior lower chamber 22.

The right side of the housing is formed by an array of vertical closure panels 12f, 12g, and 12h, and a door 32. The panels 12f, 12g, and 12h, respectively, are disposed in covering relation with, and in part form, the interior upper chamber 18, the interior upper chamber 26, and the interior lower chamber 22.

Preferably and according to this invention, an interior storage compartment 34 is formed interiorly of the housing 12 and is directly accessible by the door 32. The compartment 34 comprises horizontal shelves 36, 38 and 40, a pair of vertical walls 42 and 44, and form three horizontally separated storage areas “A”, “B”, and “C”. The lowermost shelf 40 forms, in part, the interior lower chamber 22. The walls 42 and 44 extend vertically between the top panel 12a and the shelf 40.

The door 32 comprises a plurality of first and second doors 32a and 32b disposed in side-by-side relation with one another. The doors 32a and 32b are generally rectangular in shape, associated with and cover half of a respective storage area “A”, “B”, and “C”, adapted to slide back-and-forth relative to one another and the associated storage area, and between open and closed positions. In the closed position, the storage compartment 34 and associated storage areas are substantially sealed to exterior air. For convenience, the doors, or sliding panels 32a and 32b, are transparent, such as comprised of a see-through Plexiglas material.

While a sliding closure is shown, the connection of the doors 32a and 32b to the housing 12 could be other. For example, the doors could be hingedly attached to the cart and swing outwardly. Additionally, the doors 32a and 32b for each storage area “A”, “B”, and “C” could be one-piece, hingedly attached to the cart 12, and swing upwardly.

Preferably and according to this invention, the air management system 24 and the air filtration system 20 operate to continuously circulate air through the chambers and storage compartment 18, 34, 26, and 22, remove contaminants from air passed through the storage compartment 34, and obviate stagnant air in the storage compartment 34 degrading the sensitive items stored in the storage areas “A”, “B”, and “C”. In operation, the air management system 24 provides a positive pressure that ensures that air is forced through the storage compartment and outwardly of any cracks or openings that may result if the doors 32a and 32b are not completely in the closed relation. Importantly, should one of the doors 32a and 32b somehow be inadvertently open, the positive pressure of the circulating air ensures that contaminated exterior air does not enter the compartment through the opening, but is pushed away by air being expelled from the compartment 34.

The air management system 24 includes an air blower or fan 45, a diffuser plate 46, flow control plates 48-58, and the inlet grille 28. The blower 45 is proximate to the trailing side wall 12c of the housing and has an inlet 45a to draw air from the lower chamber 28 and an outlet 45b to force high pressure high velocity air into the upper chamber 18. The blower 45 is of sufficient capacity to pull air rearwardly from the leading end of the cart and from the upper chamber 26 thereat, exterior to the cart via the grille 28, and through the lower chamber 22. Further, the blower 45 operates to pull a partial vacuum in the storage compartment 34.

Preferably, the diffuser plate 46 is disposed over the blower outlet 45b to decelerate the stream of air received from the blower 45 and from a high to a low velocity.

Further, the upper chambers 18 and 26 are formed, at least in part, respectively, by the vertical walls 42 and 44, and such as formed by the respective diffuser or flow control plates 48, 50, and 52, and 54, 56, and 58. These diffuser control plates are perforated or provided with appropriately dimensioned openings to manage the flow of air.

According to an important feature of this invention, each of the flow control plates acts as a diffuser to decelerate the velocity of the air stream passed through the plate. Further, the diffuser control plates configure the velocity profile and provide a laminar flow across the sensitive items in the respective storage chambers “A”, “B”, and “C”. The diffuser flow control plates 48, 50, and 52, extending from the top plate 12a downwardly, comprise an array of openings 60, which openings are dimensioned to pass air in an amount to render the respective plate to be 40% open, 63% open, and 50% open.

It should be noted that the desired velocities dictate the number and configuration of the perforations so that velocities are substantially the same (±20%) across each shelf is a unidirectional or laminar flow. Thus the perforations may or may not be co-axial.

Optimally, the openings 62, however, are dimensioned to render the plates 54, 56, and 60 to be 70% open.

The air filtration system 20 comprises a HEPA filter 64, of generally rectangular shape, and sized to overlay and be disposed in covering relation with the diffuser plates 48, 50, and 52. The HEPA filter 64 is commercially available and operates to filter a minimum of 99.97% of all particles 0.3 microns or larger.

For example, if the cart 10 is in an area subject to bacteria and like spores that have a minimum diameter of 0.5 microns, the HEPA filter can be expected to remove the bacteria from the air.

Further, the inside storage compartment of the cart may contain contaminants, including suspended particulate matter and residual gases. The sensitive items when stored in the compartment may give off and/or release gases, water vapor, condensates, or organic vapors. Some contaminants could react with the sensitive item and lead to unstable operations thereof. The contaminant purging filtration system herein desirably obviates such from contaminating the sensitive item.

It is important to recognize that a resistance of HEPA filters to airflow increases as the filters trap other dust and dirt particles, and a means of adjusting the fan system to accommodate this increased pressure drop should be provided.

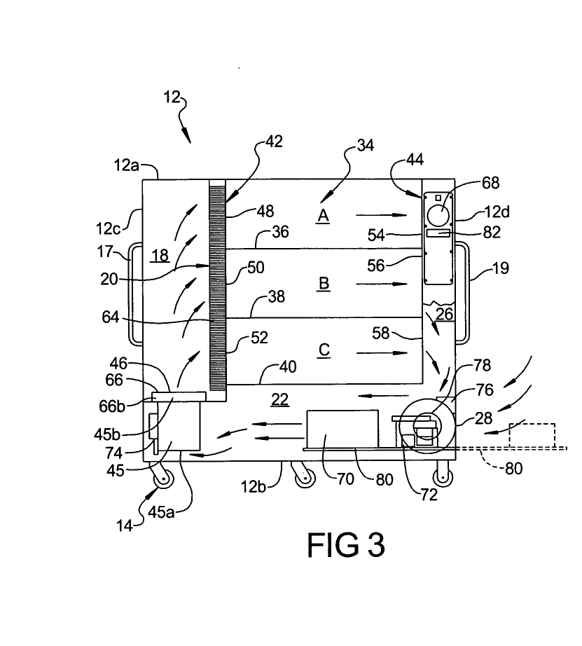

Preferably, as shown in FIGS. 3 and 7, a smoke induction tube 66 is disposed in the interior upper chamber 18, between the diffuser plate 46 and the inlet face of the HEPA filter 64, to check the filter for leakage. The tube is axially elongated, hollow, and provided with a row of spaced-apart air sampling apertures 66a. One end 66b of the tube 66 is connected to the panel 12a for connection to air sampling equipment (not shown).

Further, a pressure gauge is provided to continuously monitor pressure drop across the filter 64, such as from measuring the static pressure at a port 65. While not shown as being conventional and understood by those skilled in the fluid flow art, this pressure drop is measured and fed to a pressure monitor or gauge 68, conveniently mounted on the cart for reading by an operator during operation.

Accordingly, the HEPA filtration system has the following features: a filter mounting to prevent leakage between the filters and the supporting framework, quantitative leak testing, and a pressure-sensing or other manometer like device used in conjunction with the filter system to provide accurate means of determining the need for filter replacement.

As noted, the cart 10 is adapted to be operated both using conventional power as well as battery power. In this regard, a DC battery 70 and battery charger (inverter) 72 are mounted proximate to the grille 28, and a cable 74 connects the inverter to the motor of the blower 45.

Further, a cable 76 to connect the cart 10 to standard AC current supply is provided. In the embodiment shown, the cable is carried in a cable retractor 78 and the cable pulled out as needed, or reeled in when not in need.

In a preferred embodiment, the battery 70, and the inverter 72, are mounted on a tray 80, the tray being adapted to slide outwardly from the chamber 22 and away from the cart 10.

The cable retractor is mounted on a vertical surface adjacent the battery inverter tray 80 with a flex connection allowing the tray to slide.

To alert the operator that the battery 70 is low on energy, a voltage meter, mounted on panel 82, is connected to the inverter which monitors the battery. A flexible connection extends between the voltage meter and the inverter 72 on the sliding tray 80.

In one embodiment, the cart is approximately 6½ long, 2 feet 10 inches wide, about 5¾ feet high, and spaced ½ foot from the ground. The blower 45 delivers air at about 90-100 cfm at a suitable pressure drop across the filter face.

Referring to FIG. 3, the air circulation path in the cart 10 is depicted by the arrows. In operation, the blower 45 is turned on and a partial vacuum is drawn in the lower chamber 22. Air exterior to the cart is drawn through the grille 28, and into and through the chamber 22 at the bottom of the cart. The air is drawn into the inlet 45a of the fan and expelled via the outlet 45b at a higher velocity into the upper chamber 18.

This output air from the fan is forced through the HEPA filter 64, disposed against the vertical wall 42, forced through the openings 60 provided in the flow control plates 48, 50, and 52, and driven into the three chambers “A”, “B”, and “C”.

The pressure differential between the walls 42 and 44 and the velocity of the air generated by the fan 45 provides a generally uniform flow of air through each chamber.

The air passes through the chambers, to the vertical wall 44 and the flow control plates 54, 56, and 58 thereat and through the openings 62 provided in the flow control plates and into the upper chamber 26. This extracted or expelled air removes any contaminants that may have been in the compartment or developed by sensitive items in the chambers, as described herein above. The expelled air in the chamber, due to the operation of the fan, is drawn downwardly, into the lower chamber 28, and drawn back to the inlet 45a of the fan 45.

The recirculated, partially filtered air, is then introduced into the HEPA filter and filtered. The refiltered air is then reintroduced into the storage chambers “A”, “B”, and “C”.

Having described my invention, however, many modifications thereto will become apparent to those skilled in the art to which it pertains without deviations from the spirit of the invention as defined by the scope of the appended claims.

I claim:

1. A portable clean air cart having an interior to house and transport at least one work piece in an environment segregated from the environment external to the cart interior, the portable clean air cart comprising:
a housing that defines an accessible substantially airtight storage compartment for storing sensitive items being moved from one clean air environment to another clean air environment while passing through a lesser clean air environment, and
an air managing and air filtration system for continuously circulating air within and through the storage compartment and removing particulates from air circulated into the storage compartment to ensure that the chamber is clean and not stagnant.

2. The portable clean air cart according to claim 1, wherein
said housing includes an interior chamber, said interior chamber being subdivided to include said storage compartment,
said storage compartment includes an air inlet and outlet, respectively, for passing air into and out of said compartment, a first region for receiving and presenting circulated air to said air inlet, a second region for receiving air expelled from said air outlet, and a third region for passing air from said second region to said first region, and
said air managing and air filtration system includes a fan and an air filter, said fan for circulating air inside the interior chamber of the housing and presenting air to achieve uniform air flow at the desired velocity pressure to said air filter, and said air filter being juxtaposed with said air inlet for removing contaminants from air received from the fan and prior to being circulated into said compartment.

3. The portable clean air cart according to claim 2, wherein the air managing system preferably includes air control means for providing a generally uniform airflow between the inlet and outlet of the storage compartment, and the fan operates to provide a positive pressure in said compartment, wherein to obviate stagnant air and expel contaminated air from the compartment.

4. The portable clean air cart according to claim 3, wherein the fan operates to force air outwardly of the storage compartment.

5. The portable clean air cart according to claim 4, wherein said housing include an access door for permitting user access to said storage compartment, said access door movable between an open and a closed air tight sealed relation with the storage compartment, wherein should the access door be left ajar, the fan will force air outwardly of the compartment and inhibit contaminated air from entering the compartment.

6. The portable clean air cart according to claim 3, wherein the air control means comprises the inlet and outlet, respectively, being formed in part, by a plate having an array of air flow openings provided therein, the array of air flow openings in the inlet plate being aligned with the air flow openings in the outlet plate.

7. The portable clean air cart according to claim 3, wherein the storage compartment is subdivided into upper and lower storage areas, and the air control means comprises the inlet and the outlet, respectively, being formed, in part, by an upper and a lower plate, each plate having an array of air flow openings provided therein with the array of openings in the upper plates and the lower plates, respectively, being aligned with one another.

8. The portable clean air cart according to claim 2, wherein the storage compartment is subdivided and includes an upper, a center, and lower storage area, and the inlet and outlet to each storage area comprises a plate provided with an array of air flow openings with the openings in the plates being chosen to provide uniform flow across the three storage areas.

9. The portable clean air cart according to claim 8, wherein the airflow openings in the inlet and outlet plates, respectively, of the upper storage area are in the form of a triangular array, each array having its apex in a top corner of the plate, and of the center storage area are in the form of a rectangular or square grid, at the center of the plate, and of the lower storage area are in the form of a triangular array, each array having its apex in a bottom corner of the plate.

10. The portable clean air cart according to claim 7, wherein the number and configuration of the air flow openings is dictated by a desired air flow velocity and manner that the air flow in each storage are is substantially the same and laminar.

11. The portable clean air cart according to claim 8, wherein the storage areas of the storage compartment are accessible by one or more openable doors, wherein the positive pressure in the storage compartment by the fan continuously operates to expel filtered air from the storage compartment and inhibit contaminated air from entering into the compartment.

12. The portable clean air cart according to claim 2, wherein the air managing system further comprises an air diffuser at the outlet to the fan.

13. The portable clean air cart according to claim 2, wherein the cart is self-contained and carries means for connecting the fan to a source of electrical power,

14. The portable clean air cart according to claim 13, wherein the source of electrical power carried by the cart is a DC source of electricity.

15. The portable clean air cart according to claim 13, wherein the source of electrical power includes a DC battery, an inverter, and appropriate cabling for connecting the fan to the battery or to an external source of AC electricity.

16. The portable clean air cart according to claim 15, wherein the battery and inverter are mounted atop a slide out tray for sliding movement into and from the housing, and the housing includes a removable access panel to permit access to the battery and the inverter.

17. The portable clean air cart according to claim 2, wherein the cart is provided with means for detecting pressure drop, wherein to determine if the filter is remaining effective or needs to be changed.

18. The portable clean air cart according to claim 16, wherein the cart is provided with air inlet means for introducing constant supply of exterior air to the interior chamber, and distal to said fan.

19. The portable clean air cart according to claim 18, wherein the air inlet means comprises a grille dimensioned to pass a suitable volume of air without interfering with the fan operation, air circulation, or pressure drop, the grille being proximate to the DC battery, forms the access panel, and directs air across the battery for cooling purposes.

20. A portable cart for housing and transporting at least one work piece in a clean air environment segregated from the environment external to the cart, the portable clean air cart being self-contained and comprising:
a housing that defines an accessible substantially airtight storage compartment having a clean air environment for storing and moving sensitive items being moved between clean air environments while passing through less clean air environments,
said storage compartment including an inlet and outlet, respectively, for receiving and passing air into and out of said compartment,
said housing including:
a first region for receiving and presenting circulated air to said air inlet,
a second region for receiving air expelled from said air outlet,
a third region for passing air from said second region to said first region,
an air managing and air filtration system for continuously circulating air within and through the storage compartment and removing particulates from air circulated into the storage compartment to ensure that the compartment is clean and not stagnant, including air control means for providing a generally uniform airflow between the inlet and outlet of the storage compartment, including a fan, and an air filter, said fan for circulating air inside the housing and presenting air at a desired velocity pressure to said air filter and provide a positive pressure in the compartment to obviate and expel stagnant air from the compartment, and said air filter being juxtaposed with said air inlet for removing contaminants from air received from the fan and prior to being circulated into said compartment,
an access door for permitting user access to said storage compartment, said access door being movable between an open and a closed air tight sealed relation with the storage compartment, wherein should the access door be left ajar, the fan will force air outwardly of the compartment and inhibit contaminated air from entering the compartment,
means for connecting the fan to a source of electrical power, comprising a DC battery, an inverter, and appropriate cabling for connecting the fan to the battery or to an external source of AC electricity, and
means for detecting pressure drop, wherein to determine if the filter is remaining effective or needs to be changed.
